(19) United States
(12) Patent Application Publication
(10) Pub. No.: US 2009/0135159 A1
(43) Pub. Date: May 28, 2009

(54) TOUCH PANEL ASSEMBLY

(75) Inventor: Jeng-Hung Sun, Hsinchu City (TW)

Correspondence Address: MERCHANT & GOULD PC, P.O. BOX 2903, MINNEAPOLIS, MN, 55402-0903, US

(73) Assignee: ACROSENSE TECHNOLOGY CO., LTD., Tainan City (TW)

(21) Appl. No.: 12/275,698

(22) Filed: Nov. 21, 2008

(30) Foreign Application Priority Data
Nov. 23, 2007 (TW) 096144540
Oct. 17, 2008 (TW) 097139921

(51) Int. Cl. G06F 3/045; G06F 3/041

(52) U.S. Cl. 345/174; 345/173

(57) ABSTRACT

A touch panel assembly includes: a transparent front cover adapted to cover a screen of a display; and a touch control unit including a transparent multi-layered structure deposited on the transparent front cover. The multi-layered structure defines a plurality of transparent sensor areas, each of which is operable to sense an object when the object touches or closely approaches a location on the transparent front cover that corresponds to the respective one of the sensor areas.

### CROSS-REFERENCE TO RELATED APPLICATIONS

This application claims priorities of Taiwanese Application No. 096144540, filed on Nov. 23, 2007 and Taiwanese Application No. 097139921, filed on Oct. 17, 2008.

### BACKGROUND OF THE INVENTION

1. Field of the Invention

This invention relates to a touch panel assembly, more particularly to a touch panel assembly including a multi-layered structure deposited on a transparent front cover and defining a plurality of sensor areas.

2. Description of the Related Art

FIG. 1 illustrates a conventional touch panel display 12 that includes a housing 121 defining a window, a screen 123 mounted in the window, a touch control unit 11 disposed in the window adjacent to the screen 123, and a transparent front cover (or cover lens) 122 covering the window and bonded adhesively to the touch control unit 11 through an adhesive layer 13. The touch control unit 11 includes a substrate 111 and a touch control layer 112 formed on the substrate 111 for providing touch control functionality.

The conventional touch panel display 12 is disadvantageous in that uniformity in the layer thickness of the adhesive layer 13 is difficult to achieve and that bubbles are likely to be formed in the adhesive layer 13 during production of the touch panel display, which results in an adverse effect on the clarity of images presented on the screen 123.

### SUMMARY OF THE INVENTION

Therefore, an object of the present invention is to provide a touch panel assembly that can overcome the aforesaid drawbacks associated with the prior art.

According to this invention, there is provided a touch panel assembly that comprises: a transparent front cover adapted to cover a screen of a display; and a touch control unit including a transparent multi-layered structure deposited on the transparent front cover. The multi-layered structure defines a plurality of transparent sensor areas, each of which is operable to sense an object when the object touches or closely approaches a location on the transparent front cover that corresponds to the respective one of the sensor areas.

### BRIEF DESCRIPTION OF THE DRAWING

Other features and advantages of the present invention will become apparent in the following detailed description of the preferred embodiments of this invention, with reference to the accompanying drawings, in which:

FIG. 1 is a fragmentary sectional view of a conventional touch panel display;

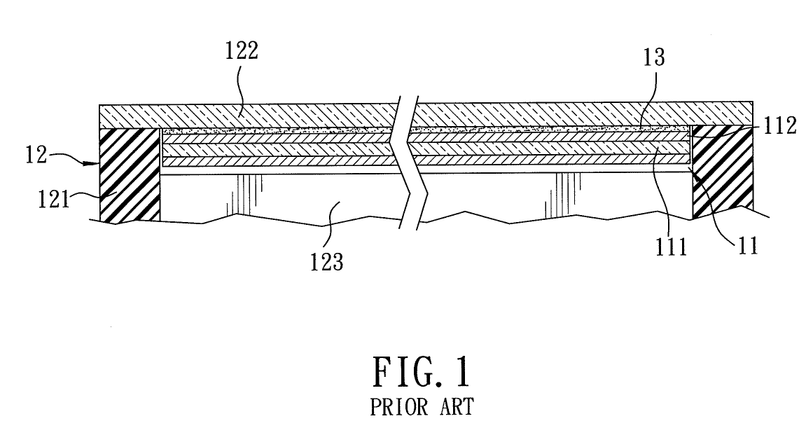

FIG. 2 is an exploded perspective view of the first preferred embodiment of a touch panel display according to this invention;

FIG. 3 is a fragmentary sectional view of the first preferred embodiment;

FIG. 4 is a fragmentary schematic view to illustrate a configuration of a touch control unit of the first preferred embodiment; and

FIG. 5 is a fragmentary sectional view of the second preferred embodiment of the touch panel display according to this invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

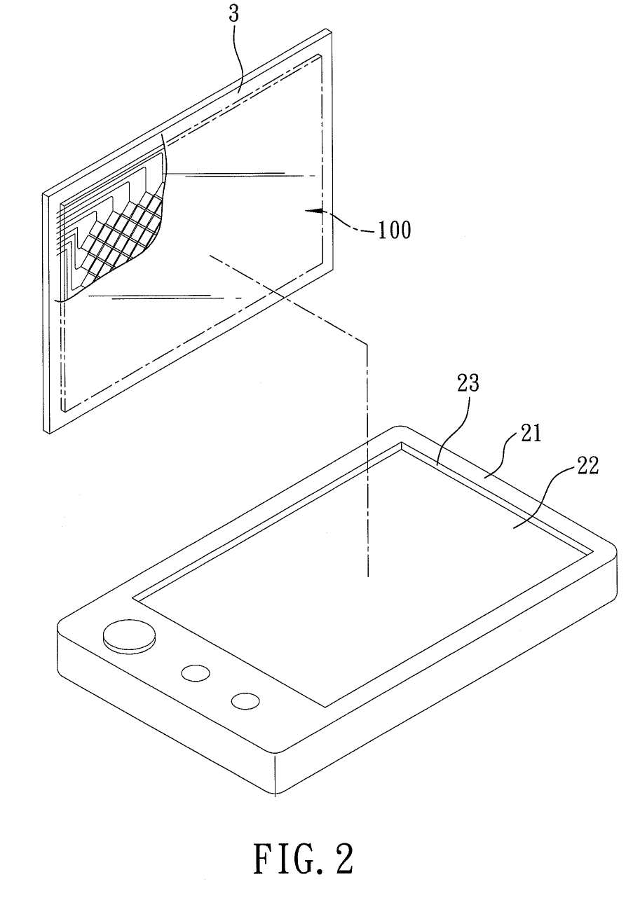

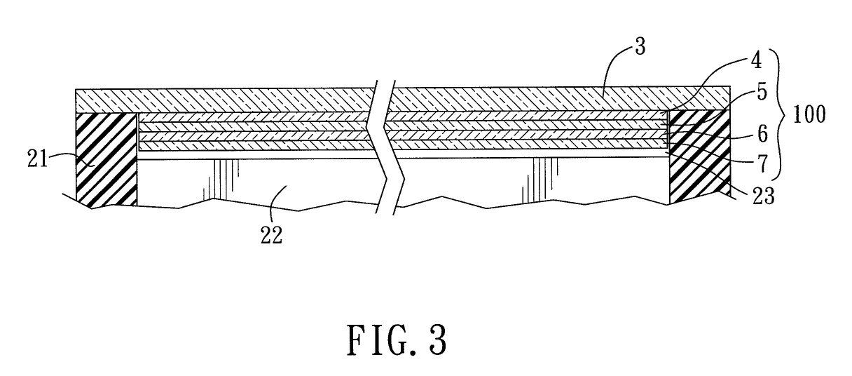

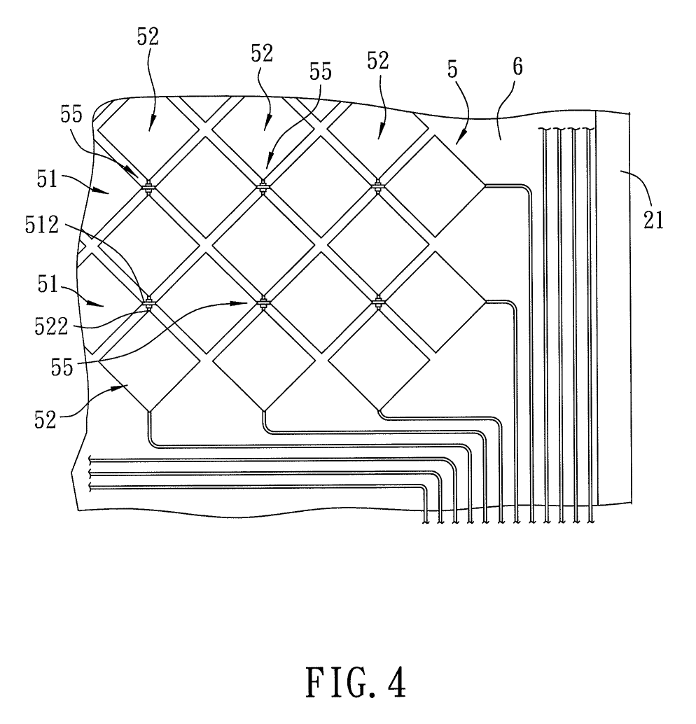

FIGS. 2 to 4 illustrate the first preferred embodiment of a touch panel display according to this invention. The touch panel display includes: a housing 21 defining a window 23; a screen 22 mounted in the window 23; and a touch panel assembly including a transparent front cover (or cover lens) 3 covering the window 23 and spaced apart from the screen 22, and a touch control unit including a transparent multi-layered structure 100 deposited on the transparent front cover 3 and disposed between the screen 22 and the transparent front cover 3. The multi-layered structure 100 defines a plurality of capacitive-type sensor areas 55 (see FIG. 4), each of which is operable to sense an object (not shown) when the object touches or closely approaches a location on the transparent front cover 3 that corresponds to the respective one of the sensor areas 55.

The front cover 3 is preferably made from a material selected from the group consisting of glass, polymethylmethacrylate (PMMA), polyvinylchloride (PVC), polypropylene (PP), polyethylene terephthalate (PET), polyethylene naphthalate (PEN), and polycarbonate (PC).

In this embodiment, the multi-layered structure 100 includes a first transparent layer 4 deposited on the transparent front cover 3 using deposition techniques, such as sputtering deposition, and a patterned sensor-forming layer 5 deposited on one side of the first transparent layer 4 opposite to the transparent front cover 3 through deposition techniques, such as sputtering deposition, and including a plurality of transparent first electrodes 51 and a plurality of transparent second electrodes 52, each of which cooperates with at least an adjacent one of the first electrodes 51 to define a capacitor therebetween. The capacitors defined by the first and second electrodes 51, 52 define the sensor areas 55, respectively. The multi-layered structure 100 further includes a second transparent layer 6 deposited on one side of the sensor-forming layer 5 opposite to the first transparent layer 4, and a grounding layer 7 deposited on one side of the second transparent layer 6 opposite to the sensor-forming layer 5.

In this embodiment, the sensor-forming layer 5 further includes a plurality of first interconnecting lines 512, each of which interconnects two adjacent ones of the first electrodes 51, and a plurality of conductive second interconnecting lines 522, each of which interconnects two adjacent ones of the second electrodes 52 and intersects insulatively an adjacent one of the first interconnecting lines 512. The first and second electrodes 51, 52 are preferably made from a transparent non-metallic conductive material, such as indium-tin-oxide (ITO), indium-zinc-oxide (IZO), aluminum zinc oxide (AZO), and combinations thereof, and are more preferably made from ITO.

In this embodiment, each of the first and second transparent layers 4, 6 serves an anti-reflection layer, and is made from a transparent electrically insulative material selected preferably from the group consisting of a metal oxide, a metal fluoride, a metal carbide, a metal nitride, or silicon oxide.

In this embodiment, the grounding layer 7 is made from a transparent conductive material, such as indium-tin-oxide (ITO), indium-zinc-oxide (IZO), aluminum zinc oxide (AZO), and combinations thereof. The grounding layer 7 serves as an electromagnetic shield for preventing external electromagnetic waves from interfering with the operation of the sensor-forming layer 5.

In this embodiment, the first and second transparent layers 4, 6, the sensor-forming layer 5, and the grounding layer 7 are formed using sputtering deposition techniques.

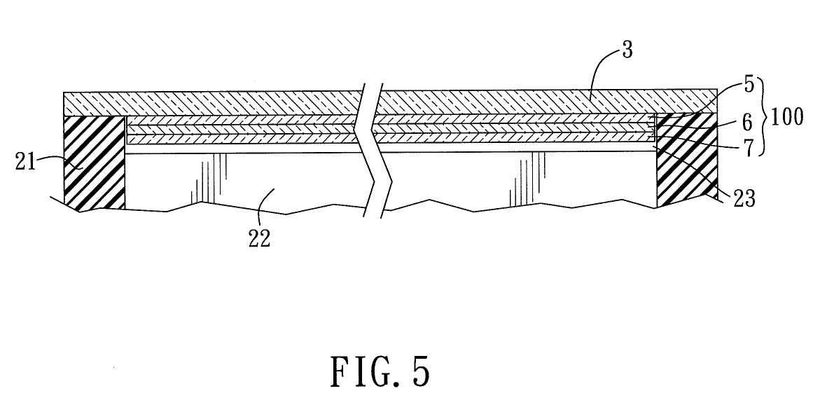

FIG. 5 illustrates the second preferred embodiment of the touch panel assembly according to this invention. The second preferred embodiment differs from the previous embodiment in that the first transparent layer 4 is dispensed with in this preferred embodiment and that the sensor-forming layer 5 is deposited directly on the front cover 3.

By depositing the multi-layered structure 100 on the front cover 3 of the touch panel assembly of the touch panel display of this invention, the aforesaid drawbacks associated with the prior art can be eliminated.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A touch panel assembly comprising:
a transparent front cover adapted to cover a screen of a display; and
a touch control unit including a transparent multi-layered structure deposited on said transparent front cover, said multi-layered structure defining a plurality of sensor areas, each of which is operable to sense an object when the object touches or closely approaches a location on said transparent front cover that corresponds to the respective one of said sensor areas.

2. The touch panel assembly of claim 1, wherein said multi-layered structure includes a patterned sensor-forming layer deposited on said transparent front cover and including a plurality of first electrodes and a plurality of second electrodes, each of which cooperates with at least an adjacent one of said first electrodes to define a capacitor therebetween, said capacitors defined by said first and second electrodes defining said sensor areas, respectively.

3. The touch panel assembly of claim 2, wherein said multi-layered structure further includes a transparent layer deposited on one side of said sensor-forming layer opposite to said transparent front cover.

4. The touch panel assembly of claim 3, wherein said multi-layered structure further includes a grounding layer deposited on one side of said transparent layer opposite to said sensor-forming layer.

5. The touch panel assembly of claim 4, wherein said grounding layer is made from a transparent electrically conductive material.

6. The touch panel assembly of claim 2, wherein said first and second electrodes are made from a transparent non-metallic electrically conductive material.

7. The touch panel assembly of claim 3, wherein said transparent layer is made from an electrically insulative material.

8. The touch panel assembly of claim 1, wherein said multi-layered structure includes a first transparent layer deposited on said transparent front cover, and a patterned sensor-forming layer that is deposited on one side of said first transparent layer opposite to said transparent front cover, and that includes a plurality of first electrodes and a plurality of second electrodes, each of which cooperates with at least an adjacent one of said first electrodes to define a capacitor therebetween, said capacitors defined by said first and second electrodes defining said sensor areas, respectively.

9. The touch panel assembly of claim 8, wherein said multi-layered structure further includes a second transparent layer deposited on one side of said sensor-forming layer opposite to said first transparent layer.

10. The touch panel assembly of claim 9, wherein said multi-layered structure further includes a grounding layer deposited on one side of said second transparent layer opposite to said sensor-forming layer.

11. The touch panel assembly of claim 10, wherein said grounding layer is made from a transparent electrically conductive material.

12. The touch panel assembly of claim 8, wherein said first and second electrodes are made from a transparent non-metallic electrically conductive material.

13. The touch panel assembly of claim 9, wherein said first and second transparent layers are made from an electrically insulative material.

14. The touch panel assembly of claim 1, wherein said transparent front cover is made from a material selected from the group consisting of glass, polymethylmethacrylate (PMMA), polyvinylchloride (PVC), polypropylene (PP), polyethylene terephthalate (PET), polyethylene naphthalate (PEN), and polycarbonate (PC).

15. A touch panel display comprising:
a housing defining a window;
a screen mounted in said window;
a transparent front cover covering said window and spaced apart from said screen; and
a touch control unit including a transparent multi-layered structure deposited on said transparent front cover and disposed between said screen and said transparent front cover, said multi-layered structure defining a plurality of sensor areas, each of which is operable to sense an object when the object touches or closely approaches a location on said transparent front cover that corresponds to the respective one of said sensor areas.
